(19) United States
(12) Patent Application Publication
(10) Pub. No.: US 2018/0339445 A1
(43) Pub. Date: Nov. 29, 2018

(54) ARTICLE OF FOOTWEAR

(71) Applicant: Wolverine Outdoors, Inc., Rockford, MI (US)

(72) Inventor: Christopher J. Loveder, Rockford, MI (US)

(21) Appl. No.: 15/964,686

(22) Filed: Apr. 27, 2018

Related U.S. Application Data
(60) Provisional application No. 62/511,626, filed on May 26, 2017.

(51) Int. Cl. B29C 64/10; B29C 64/245; A43B 23/02

(52) U.S. Cl. CPC B29C 64/10; B33Y 10/00; A43B 23/026; B29C 64/245

(57) ABSTRACT

A system and method of manufacturing an article of footwear about a footwear last that is shaped to approximate a human foot for the type of footwear being manufactured. Layers of material may be deposited on or in proximity to first and second zones of the footwear last, which may be rotated relative to a nozzle that deposits the material. For instance, the material may be deposited on a substrate provided on the footwear last.

### TECHNICAL FIELD

The present application relates to footwear, and more particularly toward an additive manufacturing system and process for an article of footwear.

### BACKGROUND

Conventional articles of footwear include an upper and a sole structure secured to a lower surface of the upper. The upper provides a void that receives a person's foot and positions the foot with respect to the sole structure. The sole structure may provide traction or cushion for the foot under a variety of conditions, e.g., walking, running or standing, or a combination thereof. Conventional uppers are formed from conventional materials, such as injection molded polymers, fabric manufactured from spooled yarn or thread, and leather or leather-like materials, that are fit and assembled about a last that provides a 3-D shape for a foot. The last may be a conventional and standard last for a line of footwear, such as a size 11 for a line of work boots. The upper may include more than one layer of materials to define an exterior layer, an intermediate layer, and an interior layer.

In many cases, multiple types of materials form sections that are joined together to form the upper. These sections may be obtained in a conventional manner by cutting the material from a larger sheet of material (e.g., a sheet of textile), injection molding techniques, and knitting or weaving a finished textile section. Synthetic or natural materials may be used in creating these sections, which are often joined and formed about the last to produce the upper. In this way, the sections are mechanically manipulated into conforming to the 3-D contour of the last.

These conventional techniques and materials in many cases rely on manufacturing processes that are slow to adapt to design changes or result in a limited selection of designs. As an example, the typical design process from conception to manufacture of a footwear may take several months or perhaps a year to complete.

There have been efforts to generate footwear related products using conventional additive manufacturing or 3-D printing techniques. For instance, 3-D printing techniques have been utilized to create inserts or insoles that can be customized to parameters of a particular user, such as a tendency toward pronation or supination, or a need for arch support. However, the conventional 3-D printing techniques utilized for these types of footwear products have limitations.

Conventional 3-D printing techniques involve building an object in successively deposited layers starting with a substantially flat surface described as a bed. The layers are stacked on top of each other to form the object. With this approach, a variety of objects can be manufactured including objects with voids. But the primary downside to this approach is the inability to incorporate a secondary object into the object being manufactured without placing the secondary object directly on the bed or introducing the secondary object after layers of the object have already been deposited. This and other limitations of conventional 3-D printing techniques limit the number and type of products that can be manufactured with a 3-D printer in the realm of footwear.

### SUMMARY OF THE DESCRIPTION

The present disclosure is directed to a system and method of manufacturing an article of footwear about a footwear last that is shaped to approximate a human foot for the type of footwear being manufactured. Layers of material may be deposited on or in proximity to first and second zones of the footwear last, which may be rotated relative to a nozzle that deposits the material. For instance, the material may be deposited on a substrate provided on the footwear last.

In one embodiment, the method of manufacturing an article of footwear is provided that includes providing a footwear last shaped to approximate a human foot for the type of footwear being manufactured, where the footwear last approximates the stick length, ball girth, and instep girth of the human foot, the footwear last having a bridge zone of an upper surface, a sole zone of a lower surface, a medial surface, and a lateral surface. The method may include depositing material from a nozzle unit on or in proximity to a first zone of the footwear last, rotating the footwear last relative to the nozzle unit, and depositing material from the nozzle unit on or in proximity to a second zone of the footwear last. The method may include separating the material deposited from the nozzle unit and the footwear last to yield the footwear with a void that accepts the human foot.

In another embodiment, an article of footwear may include an upper formed at least in part of material deposited by a nozzle unit on or in proximity to a footwear last that is held in space relative to a nozzle unit. The material is deposited with the nozzle unit being aligned with a normal to a first surface at a first position of the footwear last, and deposited with the nozzle unit being aligned with a normal to a second surface at a second position of the footwear last. The first surface may be opposite the second surface, where the normal to the first surface is parallel with the normal to the second surface.

In yet another embodiment, a method of manufacture for an article of footwear is provided that includes mechanically manipulating a yarn with a knitting machine to form a knitted portion of an upper having a void that accepts a human foot, and disposing the knitted portion over a footwear last shaped to approximate the human foot for the type of footwear being manufactured. The footwear last may approximate the stick length, ball girth, and instep girth of the human foot, and have a bridge zone of an upper surface, a sole zone of a lower surface, a medial surface, and a lateral surface. The method may include depositing material from a nozzle unit on the knitted portion to provide at least one of an upper feature and an outsole.

In a further embodiment, a manufacturing system for producing an article of footwear is provided that may include a footwear last, a nozzle unit, and an articulating manipulator. The footwear last may be disposable within an upper element defining an ankle opening and a void in an interior of the footwear to receive a human foot, and configured to extend around a heel area of the human foot, over the toe area of the human foot, and along medial and lateral sides of the foot. The footwear last may include first and second surface normals that are not parallel.

The nozzle unit may be configured to deposit material in layers on an upper element, and to deposit material along a vertical deposition axis. The articulating manipulator may be configured to vary a relative position between the footwear last and the nozzle unit to align the vertical deposition axis and the first normal, and to vary the relative position between the footwear last and the nozzle unit to align the vertical deposition axis and the second normal.

In still a further embodiment, an article of footwear may include an upper element, a first plurality of layers, and a second plurality of layers. The upper element may define an ankle opening and a void in an interior of the upper to receive a human foot, and may be element configured to extend around a heel area of the human foot, over a toe area of the human foot, and along medial and lateral sides of the foot. The first plurality of layers may be deposited by a nozzle unit on the upper element along a first deposition axis, and the second plurality of layers may be deposited by the nozzle unit on the upper element along a second deposition axis. The first deposition axis may be different from the second deposition axis such that the first plurality of layers is built along a direction different from a build direction of the second plurality of layers.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows aspects of a footwear generation system according to one embodiment;

FIG. 2 shows the footwear generation system of FIG. 1 with a representative footwear last;

FIG. 3 shows an articulating manipulator according to one embodiment;

FIG. 4 depicts a method of manufacture according to one embodiment;

FIG. 5 depicts a system of calibration according to one embodiment;

FIG. 6 shows a substrate in accordance with one embodiment;

FIG. 7 shows the substrate of FIG. 6 with 3-D printed components and the substrate greyed out;

FIG. 8 shows an alternative view of FIG. 7 with the 3-D printed components and the substrate without being greyed out;

FIG. 9 depicts an article of footwear according to one embodiment with a 3-D printed midsole and outsole; and

FIG. 10 shows the article of footwear of FIG. 9 with color blocking.

### DESCRIPTION

A system and method according to one embodiment includes manufacturing an article of footwear about a footwear last that is shaped to approximate a human foot for the type of footwear being manufactured. The footwear last approximates the stick length, ball girth, and instep girth of the human foot, and includes an upper surface with a bridge zone, a lower surface with a sole zone, a medial surface, and a lateral surface. Layers of material may be successively deposited on or in proximity to first and second zones of the footwear last, which may be rotated relative to a nozzle that deposits the material. For instance, the material may be successively deposited near the bridge zone at a first normal to the footwear last, and successively deposited near an instep area of the footwear at a second normal that is more than 180° different from the first normal. An article of footwear according to one embodiment includes an upper element defining an ankle opening and a void in an interior of the upper to receive a human foot, and extending around a heel area of the human foot, over a toe area of the human foot, and along the medial and lateral sides of the foot. First and second pluralities of layers may be deposited by a nozzle unit onto the upper element along a deposition axis that is different for each of the layers, so that the buildup direction for the first plurality of layers is different from the buildup direction for the second plurality of layers.

I. Overview

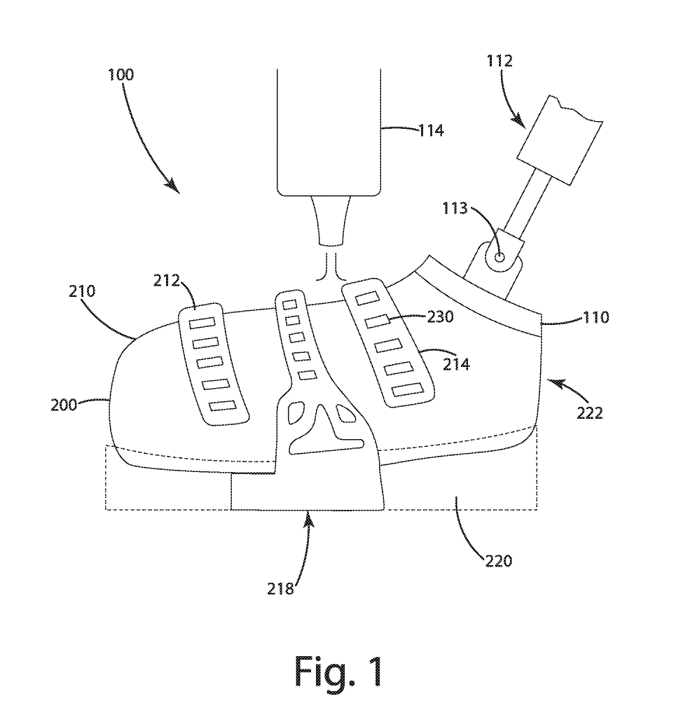

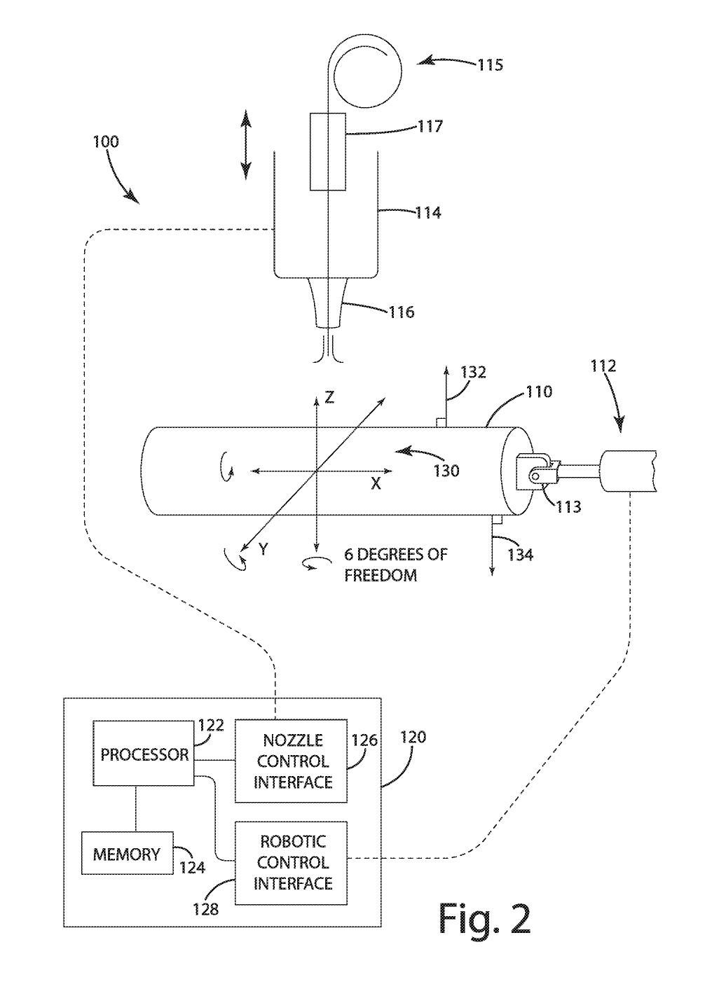

In the illustrated embodiments of FIGS. 1 and 2, an article of footwear and a system for manufacturing the article of footwear is shown, and generally designated 200, 100, respectively. It should be noted at the outset that, for purposes of disclosure and understanding, the footwear last 110 is depicted in FIG. 2 as a basic cylinder instead of being shaped to approximate a foot—this has been done intentionally to aid in understanding the frame of reference 130 and normal vectors 132, 134 relative to surfaces of the footwear last 110. In practice, the footwear last 110 is a more complex 3-D object with variations in surface curvature in order to approximate the human foot.

II. Additive Manufacturing System

The additive manufacturing system 100 may include an articulating manipulator 112, e.g., a robotic arm, that can be releasably coupled to a footwear last 110, which is an approximation of a human foot. The footwear last 110 may be decoupled from an end effector 113 of the articulating manipulator 112 so that a footwear last 110 of a different type may be coupled to the articulating manipulator 112 for production of a different article of footwear. For example, end effector 113 of the articulating manipulator 112 may be configured to releasably couple to footwear lasts 110 of varying stick lengths (e.g., size 6 and size 12).

The additive manufacturing system 100 may include a nozzle unit 114 capable of depositing material 115 in successive layers to form one or more features of the footwear 200. As discussed herein, the additive manufacturing system 100 may enable deposition of layers along a different buildup axes or different deposition axes. For instance, the nozzle unit 114 may be arranged to deposit the material 115 near an instep area of the footwear last 110 at a deposition axis that is substantially aligned with a normal vector of the instep area. The nozzle unit 114 and footwear last 110 may be repositioned so that the material 115 can be deposited near a bridge area of the footwear last 110 with the deposition axis repositioned to substantially align with a normal vector of the bridge area. In this arrangement, the normal vectors of the bridge area and the instep area are different from each other.

In the illustrated embodiment, the additive manufacturing system 100 may include an additive manufacturing controller 120 adapted to control operation of the nozzle unit 114 and the articulating manipulator 112. The additive manufacturing controller 120 in the illustrated embodiment of FIG. 2 includes one or more of the following: a processor 122, memory 124, a nozzle control interface 126 for directing the nozzle unit 114, and a manipulator control interface 128 for directing the articulating manipulator 112. The additive manufacturing controller 120 may optionally include an input interface (not shown) or an output interface (not shown), or both, to enable communication with devices other than the nozzle unit 114 and the articulating manipulator 112. For instance, the input interface may include one or more input communication interfaces, including, for example, wired communication and wireless communication capabilities. Likewise, the output interface may include one or more output communication interfaces, including at least one wired interface and at least one wireless interface, or any combination thereof. The processor 122 and memory 124 may be configured to direct the nozzle control interface 126 and the manipulator control interface 128 to operate the nozzle unit 114 and articulating manipulator 112 in conjunction with each other to successively deposit layers of the material 115 relative to the footwear last 110.

The additive manufacturing controller 120 is configured according to the illustrated embodiment to obtain G-Code from a 3-D model module executable on or separate from the additive manufacturing controller 120. The G-Code may be generated from a 3-D model of the object to be manufactured, and is based on a plurality of slices or layers of the 3-D model to generate a deposition path for each layer. In a conventional additive manufacturing system, the deposition path corresponds to two dimensional movement of a nozzle relative to the object being manufactured, or in other words, a two dimensional slice or layer. One embodiment according to the present invention generates a deposition path for each layer that may include movement in at least one of six degrees of motion, X, Y, Z, pitch, roll, and yaw depicted in the reference frame 130, for the relative position of the footwear last 110 and nozzle unit 14. For instance, the deposition path for a layer being deposited in proximity to the footwear last 110 may include motion of the footwear last 110 in X, Y, and Z directions as well as roll about the X-axis. The deposition path for a layer according to one embodiment may include at least one of pitch, roll and yaw as well as motion in at least one of the X, Y, and Z directions.

Optionally, the nozzle unit 114 may be configured to move in one or more of the degrees of freedom defined in the reference frame 130, including the Z-axis.

The layers or slices according to one embodiment may correspond substantially to a three-dimensional contoured surface. Depositing this type of three-dimensional deposition layer may involve motion in at least one of pitch, roll and yaw as well as motion in at least one of the X, Y, and Z directions. Additionally or alternatively, the layers or slices may correspond to a plurality of deposition paths that are two-dimensional. After deposition of a two-dimensional layer, the footwear last 110 may be rotated (e.g., one or more of pitch, yaw, and roll) and another two-dimensional deposition layer can be deposited.

The G-Code obtained by the additive manufacturing controller 120 may correspond to a series of commands for operating the articulating manipulator 112 and the nozzle unit 114, and may include but is not limited to instructions relating to position, speed, or temperature, or any combination thereof. The G-Code, for example, may include an instruction for the articulating manipulator 112 to return the end effector 113 to a home position. As another example, the G-Code may instruct the nozzle unit 114 to change the extrusion temperature for the material 115. Although described in connection with G-Code, it should be understood that the additive manufacturing controller 120 may receive any type of instructions relating to operation of the articulating manipulator 112 and the nozzle unit 114 to deposit material in proximity to the footwear last 110.

In the illustrated embodiment, the nozzle control interface 126 of the additive manufacturing controller 120 may be configured to direct one or more aspects of the nozzle unit 114, including extrusion temperature, flow rate of the material 115 through a nozzle 116 of the nozzle unit 114, and type of material being deposited. The nozzle unit 114 may include more than one nozzle 116 or more than one extruder 117, or any combination thereof, so that multiple types of material 115 may be used in conjunction with a single build without changing out the type of material 115 in the middle of a build job. The nozzle control interface 126 may be configured to direct operation of the nozzle unit 114 so that different types of the material 115 may be deposited at different times. Examples of different materials capable of being deposited during a single job include different colored materials, materials of different densities, and materials of different composition, such as polylactide (PLA) and foam.

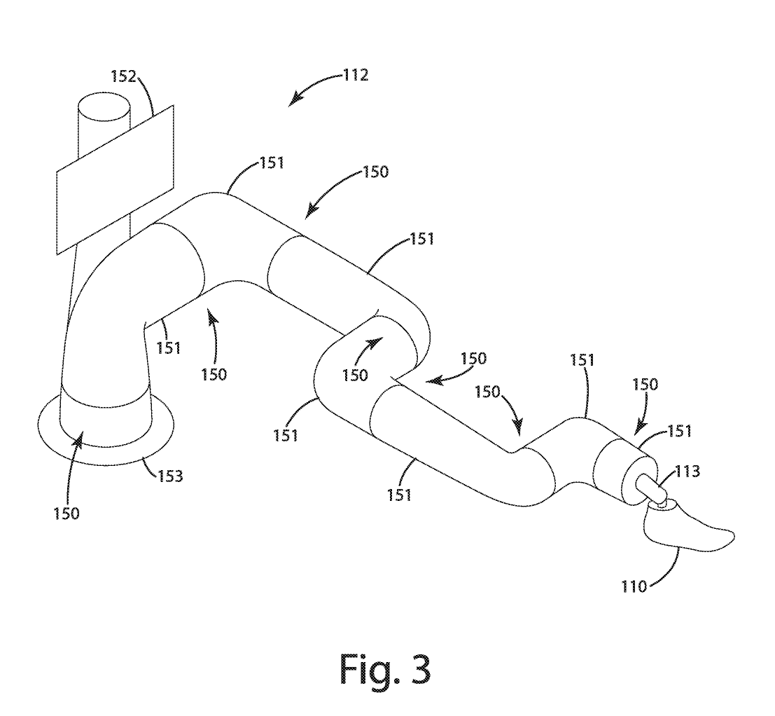

In the illustrated embodiment of FIG. 3, the articulating manipulator 112 is shown in accordance with one embodiment. The articulating manipulator 112, as described herein, may include the end effector 113 configured to releasably couple to the footwear last 110 to enable operation with a plurality of footwear lasts 110 of different types. The articulating manipulator 112 may include a base 153 and a plurality of arms or links 151 joined via joints 150, which provide range of motion between adjacent links 151 or the base 153 and an adjacent link 151. For instance, each joint 150 may enable relative rotation between adjacent links 151 that is greater than or equal to 180°, 340°, 350°, or 540°, or any combination thereof. The joint 150 nearest to the base 153 may provide approximately 340° rotation between the base 153 and link 151, and the joint 150 nearest to the end effector 113 may provide approximately 540° rotation between the adjacent links 151.

The range of motion provided by the joints 150 enables the articulating manipulator 112 to move and reposition the end effector 113 and footwear last 110 in space relative to the nozzle unit 114. The range of motion may include at least one of a) linear movement in one or more of the X-axis, Y-axis, and Z-axis directions and b) rotational movement about one or more of the X-axis, Y-axis, and Z-axis (e.g., roll, pitch, and yaw). The articulating manipulator 112 may be configured to position the footwear last 110 relative to the nozzle unit with a tolerance of 0.2 mm or less, preferably 0.1 mm or less (100 microns or less) or 0.01 mm or less. The positional tolerance of the articulating manipulator 112 may be maintained in motion such that the deposition path of the nozzle unit 114 is accurate within 0.2 mm or less, preferably 0.1 mm or less or 0.01 mm or less.

In one embodiment, the articulating manipulator 112 may be configured to automatically select a footwear last 110 from a plurality of footwear lasts 110 of different types for manufacture of an article of footwear. The articulating manipulator 112 may position the end effector 113 to a change position at which a footwear last 110 can be coupled to the end effector 113, at which a footwear last 110 can be decoupled from and exchanged for another footwear last 110. Automatic selection and coupling of the footwear last 110 to the articulating member 112 may provide enhanced efficiency in manufacture of the footwear.

In one embodiment, the automatic selection and coupling of the footwear last 110 may enable adaptive manufacture of footwear based on custom instructions from a point of sale or point of transaction so that a production line for footwear may quickly change from one type of footwear and footwear last to another type of footwear and footwear last. For instance, the production line may be configured to manufacture footwear on demand such that customized footwear ordered by one individual may be queued for manufacture behind a different footwear construction scheduled for manufacture in connection with the articulating manipulator 112.

The articulating manipulator 112 may include control circuitry configured to respond to control signals received from the manipulator control interface 128 of the additive manufacturing controller 120. For instance, the manipulator control interface 128 may provide instructions via serial link to the articulating manipulator 112 to move to a particular position or to move from one position to another position along the path at a desired speed. In this way, the manipulator control interface 128 may direct deposition of the material 115 onto or in proximity to a location of the footwear last 110.

As described herein, the footwear last 110 may be releasably coupled to the end effector 113 of the articulating manipulator 112. The releasable coupler for each of the footwear lasts 110 may be configured to provide repeatable and accurate positioning between the footwear last 110 and the end effector 113. Accuracy in depositing the material 115 may be maintained with this approach, after the articulating manipulator 112 has been calibrated with respect to the position of the end effector 113.

Additionally, or alternatively, the articulating manipulator 112 may include one or more sensors (not shown) configured to sense alignment of the footwear last 110 relative to the nozzle unit 114. In one instance, the footwear last 110 may include one or more registration marks or identifiers that can be sensed by the one or more sensors to calibrate position of the footwear last 110 relative to the nozzle unit 114. After the footwear last 114 is coupled to the end effector 113, the manipulator control interface 128 may direct the articulating manipulator 112 to calibrate position with respect to the footwear last 114 so that position in the additive manufacturing process to follow is substantially accurate. The one or more registration marks may include a visual identifier detectable via a vision system, or a physical aspect that can be sensed with a force sensor. For instance, a force sensor may be coupled to the articulating manipulator 112 to detect a position of contact between the nozzle unit 114 and the footwear last 110. Based on the position of contact for one or more orientations, the additive manufacturing system 100 may calibrate itself for manufacture of footwear or a feature thereof via additive manufacturing or layered deposition of the material 115.

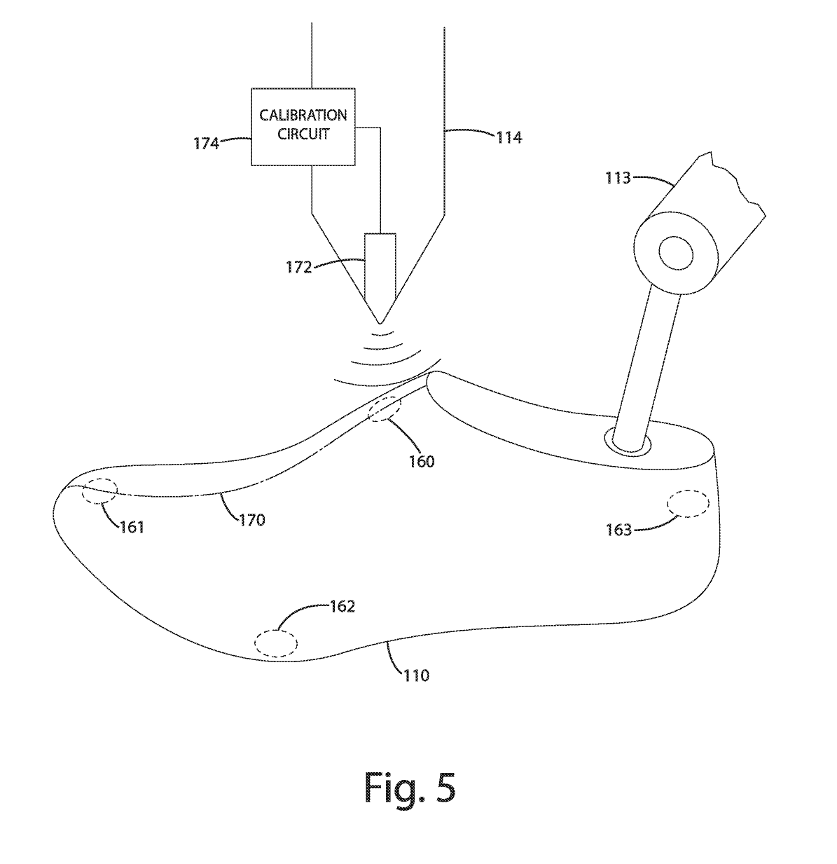

A calibration configuration according to one embodiment is shown in FIG. 5. The calibration configuration may be incorporated into the additive manufacturing system 100, and may rely primarily on an inductive proximity sensor 172 and calibration circuitry 174 disposed in the nozzle unit 114 to calibrate a position of the footwear last 110 relative to the nozzle unit 114. In the illustrated embodiment, the footwear last 110 includes one or more registration objects 160-163 formed of metal detectable by the inductive proximity sensor 172 and disposed at specific and known locations of the footwear last 110. The footwear last 110 may be brought into proximity to the inductive proximity sensor 172 at various positions corresponding generally to the locations of the one or more registration objects 160-163. Based on the sensed effect of each registration object 160-163 on the inductive proximity sensor 172 at each location, and the known location of the registration object 160-163 at the location, the calibration circuitry 174 may calibrate a location of the footwear last 110 relative to the nozzle unit 114.

As an example, the inductive proximity sensor 172 may be brought into proximity to the registration object 160 disposed along a central axis 170 of the footwear last 110. The depth of the registration object 160 relative to the surface of the footwear last 110 may be known, as well as the location of the registration object 160 relative to one or more aspects of the footwear last 110, such as another registration object 160. Conducting several measurements of the effect of the registration object 160 on the inductive proximity sensor 172 at various distances may provide a reference profile indicative of the relative distance of the registration object 160 to the nozzle 116. A similar set of measurements may be obtained with respect to the registration object 161 located at or near the toe of the footwear last 110 and along the central axis 170. The measurements may be compared to calibrate a location of the footwear last 110 in relation to the nozzle 116.

III. Substrate

In the illustrated embodiment of FIG. 1, the article of footwear 200 is shown with a substrate 210 disposed about the footwear last 110 and on which the material 115 is being deposited.

The substrate 210, as discussed herein, may be a knit material similar to a sock that is slipped over the footwear last 110 prior to deposition. It should be understood that the present disclosure is not limited to a particular type of substrate 210; indeed, one embodiment of the present disclosure does not include a substrate 210. The substrate 210 may define all or part of the interior void that accepts a human foot. In the example substrate 210 of the illustrated embodiment, the substrate defines the entire void. Alternatively, the substrate 210 may expose surface areas of the footwear last 110, such as in the case of an open-toed sandal. Although described in connection with a knit material, the substrate 210 may be any type of textile material (e.g., woven or otherwise) or include any type of materials, including one or more of leather, synthetic material, a polymer material, or any combination thereof.

In one embodiment, the footwear last 110 may be utilized in conjunction with a release mechanism that facilitates direct deposition of material 115 on the footwear last 110 and separation of the footwear last 110 from the material 115. Example release mechanisms include a spray on material that is soluble with respect to a removal agent, and a heated footwear last 110 that when heated, may loosen any bond that exists between the material 115 and the footwear last 110 to aid separation of the material 115 from the footwear last 110.

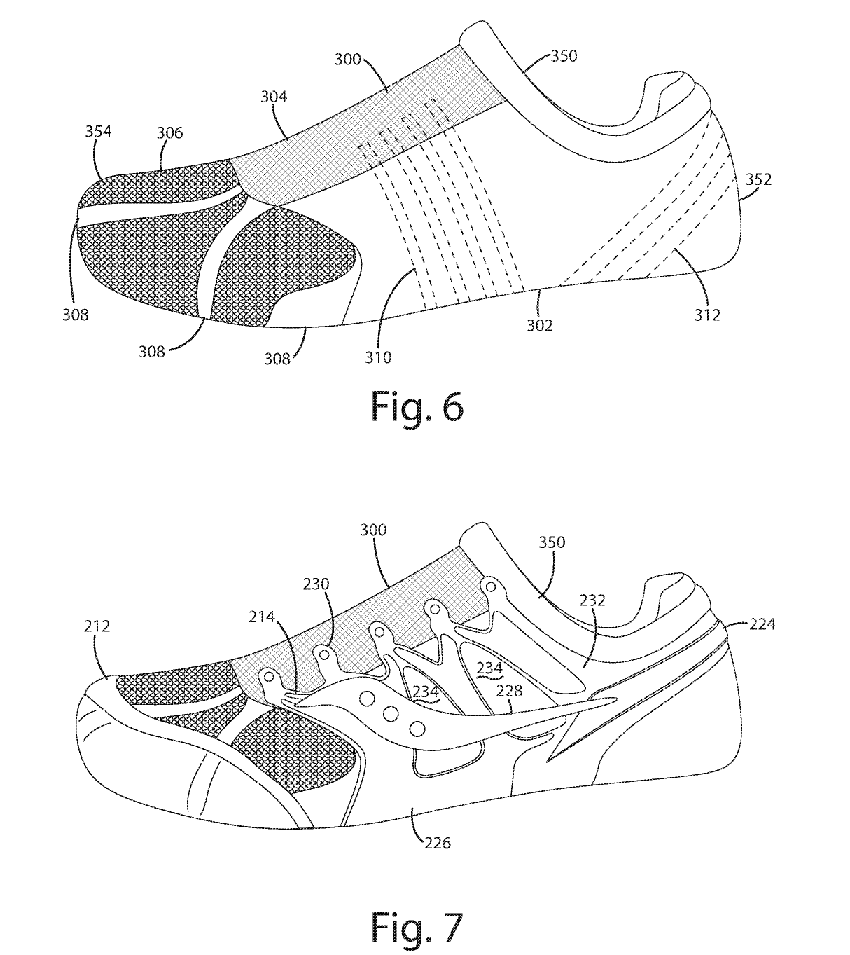

The substrate according to one construction is depicted in the illustrated embodiment of FIG. 6, and generally designated 300. The substrate 300 includes textile material that may include webs of filaments or fibers or mechanically manipulated yarn. The web of filaments may be interlocked in a random manner to yield a non-woven fabric or felt that defines at least part of a void that accepts a human foot and fits on the footwear last 110. In one embodiment, the substrate 300 may be deposited, via an additive manufacturing process, on the footwear last 110. As another example, the substrate 300 or a portion thereof may be injection molded polymer.

In embodiments that utilize a substrate 300 formed at least in part from yarn, the yarn may be woven or knit, or any other type of mechanical manipulation to yield a substrate 300 that forms at least part of a void that accepts a human foot and fits over the footwear last 110. The mechanically manipulated yarn may include at least one filament or a plurality of fibers that together form a material that is significantly long relative to its cross section. Example materials that may provide the basis for the yarn are cotton, elastomer, nylon, polyester, polyacrylic, rayon, silk and wool, or a combination thereof. In one embodiment the yarn may include one or more fusible strands that may melt when heated to join with adjacent fibers or materials.

Knit constructions of the substrate 300 may be produced in a variety of ways, including warp knitting or weft knitting. In the context of warp knitting, numerous individual strands of yarn (e.g., the warp) may be guided to needles in the flow direction of a knitting machine. Several types of knitting machines can provide a warp knit construction, including tricot, raschel, and double needle-bar raschel or jacquard double needle-bar raschel.

In the context of weft knitting, the yarn may be mechanically manipulated by a knitting machine to direct the yarn to needles of the knitting machine so that the yarn proceeds across a flow direction of the knitting machine. Knitting machines capable of this type of construction include those capable of circular knitting (e.g., sock knitting or jacquard) or flat knitting.

Each technique for mechanically manipulating the yarn to yield the substrate 300 may enable production of one or more features incorporated into the substrate 300. For instance, the substrate 300 may knit to yield a three-dimensionally curved structure, as depicted in the illustrated embodiment of FIG. 5. As another example, multiple types of yarn types may be introduced into the substrate 300 to yield a variety of effects, including color variety or material properties that vary between different areas. For instance, yarn having different properties relative to a principal yarn of the substrate 300 (e.g., increased tensile strength or greater stretch resistance) may be laid into the substrate 300 from the bridge, lateral side across the instep to bridge, medial side and back multiple times to form loops on the medial and lateral sides. The loops may provide support for a plurality of lace apertures disposed in the substrate 300. Alternatively, or additionally the loops, themselves, may function as lace supports to facilitate tightening of the footwear 200 about the foot. Inlaid strands according to this configuration are shown in phantom lines designated 310 in the illustrated embodiment of FIG. 6. The yarn having different properties, as discussed herein, such as the inlaid strands 310, may be made of a variety of materials and material configurations, depending on the application, including but not limited to engineered filaments, cotton, elastomer, polyester, rayon, wool, and nylon. As an example, any one or more of these materials may be configured into a strand of yarn that forms a cable, chain, filament, thread, or rope, and with a cross sectional shape that can be any one or more of irregular, round, or an N-sided polygon (e.g., square or triangular).

In one embodiment, yarn with different properties relative to a principal yarn of the substrate 300 may be provided near a heel cup of the substrate 300 to provide additional strength in this area of the substrate 300. Yarn designated 312 and shown in phantom lines in the illustrated embodiment depict this optional type of configuration. The yarn 312 may function similar to a heel counter to provide support to the foot received within the void of the substrate 300. In this way, the yarn may provide support to the substrate 300 in use such as by enhancing resistance against deformation in use.

Alternatively, or additionally, yarn having a different property from the principle yarn of the substrate 300 may be provided around all or a substantial portion of an ankle opening 350 to impart additional strength in this area. For instance, one or more elastomeric strands may be inlaid around the ankle opening 350 to support a human foot or aid in preventing the human foot from pulling out of the ankle opening 350 at an inopportune or undesired time.

The substrate 300 according to one embodiment may include areas or zones having different stitch configurations that can be imparted into the substrate 300 by changing operation of the knitting machine. For instance, the type of stitches effected by needle operation of the knitting machine may vary as the substrate 300 is knit. The knitting machine may be configured to operate its needles according to a variety of stitch types, including but not limited to a lace stitch, a slip stitch, a fair isle stitch, a weaving stitch, a skip stitch, and a tuck stitch. Varying the stitch configuration among areas or zones that are adjacent to each other may enable development of a pattern on the substrate 300 or areas that provide greater support or rigidity relative to other areas. Different stitch configurations are not necessarily different stitch types according to one embodiment. Different stitch configurations may involve use of different types of yarns, such as different color yarns or different combinations of yarns. Another example of a different configuration is incorporation of a spacer knit construction in one or more zones of the substrate 300.

In the illustrated embodiment of FIG. 6, the substrate 300 includes several zones or areas having different constructions. For instance, a majority of the medial side and lateral side from the heel counter 352 to the toe box is formed of a first type 302, whereas the bridge area of the substrate 300 is formed of a second type 304. The second type 304 may be more pliable (e.g., rib stitching) in a direction transverse to the longitudinal axis, whereas the first type 302 may be more rigid in all directions, such that the bridge area may be more flexible or pliable than the medial and lateral sides in order to enable expansion for variances in foot size without degrading support characteristics of the substrate 300. In one embodiment, the first type 302 may include multiple layers fused together, via fusible yarn or adhesive, and the second type 304 may include none or less fusing to provide more pliability over the first type 302.

It is noted that, in one embodiment, fusing of materials may be achieved during manufacture with a heated version of the footwear last 110. Alternatively, fusing of the materials may be achieved via a separate type of last or form construction that imparts heat to substrate 300.

The substrate 300 may include one or more additional areas of varying construction types, such as the third type 306 and the fourth type 308 near the toe box 354. In some configurations, a variance in construction type for different areas is not driven solely by functional attributes, such as greater strength or pliability in one area over another or ventilation. That is, in some configurations, a variance in construction type may be based at least in part on providing patterns or elements that enhance the look and feel of the substrate 300. The knitting machine may be configured to knit the substrate 300 to yield such variances in patterns or provision of elements. Example elements include the strips 308 near the toe box 354, apertures or openings (e.g., lace holes), or tubes defined between adjacent knit layers (e.g., that accept a longitudinal length of a lace that is significantly longer than a cross-sectional area of the lace).

The knit construction of the substrate 300 may provide a knit construction according to one embodiment that is flat knit with finished edges that can be joined together to form a void and ankle opening 350 for receiving a human foot. Alternatively, the substrate 300 may be circular knit in the general shape of a tube that may be folded over itself with ends being stitched together to form a sock shape. The adjacent layers of such a substrate 300 may be fused together, according to one or more embodiments described herein, including for example fusible yarn incorporated into the knit material or adhesive. In yet another embodiment, the knit construction may be provided in bulk form or as a roll of textile material that can be die cut according to a template corresponding to the shape of the substrate 300.

Although the substrate 300 in the illustrated embodiment of FIG. 6 is formed of a seamless knit construction with areas or different zones of having different properties, such as one or more of color, material types, knitting construction, and one or more supplemental materials (e.g., adhesive), it should be understood that an area or zone of the substrate 300 may be manufactured separately and joined to the substrate 300. Areas or zones of the substrate 300 may include more than one layer of material, including multiple layers of knit material, polymer material, or another type of material, or a combination thereof.

In one embodiment, the substrate 300 may be formed entirely of textile material as a unitary upper with edges joined together along the bottom from the heel to the toe. The edges may be joined directly or may be joined together indirectly via a Strobel board.

In an alternative embodiment, the substrate 210, 300 may include an outer layer manufactured from one or more pieces of material that are joined together to form a foot containing space or a void for receiving a human foot. The one or more pieces of material may include one or more textile components or one or more components other than textile, such as leather or polymer, or any combination thereof. The outer layer may be manufactured from a single type of material or from a combination of two or more materials. For example, the outer layer may include a primary material, such as leather (e.g., full grain leather), and a secondary material, such as a textile element (similar in some respects to the knitted version of the substrate 210, 300) or nylon fabric (e.g., 1680 denier nylon fabric) that are joined together by sewing and/or adhesive. The substrate 210, 300 may also include internal lining materials.

In one embodiment, the substrate 210, 300 may include additional components, such as a heel counter, a composite toe and/or internal padding. For example, the substrate 210, 300 may include padding in the collar forming the ankle opening 350 where the top portion of the substrate 210, 300 will engage the wearer's body. The bottom of the substrate 210 may be closed using an insole board, such as lasting board. For example, the substrate 210, 300 may be fitted over the footwear last 110 or another footwear last and its bottom peripheral edge may be secured to the lasting board using conventional techniques and apparatus. The substrate 210, 300 may be closed using alternative constructions, such as other types of lasting boards.

The substrate 210, 300 according to one embodiment may include one or more apertures or openings that provide ventilation or access for other elements. As an example, the substrate 210, 300 may include lace openings or apertures. In another example, as discussed herein, the substrate 210, 300 may include extended channels through which laces or other elements may be disposed. The extended channel in one embodiment may extend partially from the instep to an opening in the substrate 210, 300 that accepts the foot within the void defined by the substrate 210, 300. The extended channel in one configuration may accept loops anchored near the sole with a loop near the opening of the substrate 210, 300 or near a tongue to accept laces.

IV. Article of Footwear

An article of footwear 200 incorporating the substrate 210, 300 in accordance with an embodiment of the present disclosure is shown in FIGS. 1 and 7. The article of footwear 200 may include an upper 222 and a sole 220. The article of footwear 200 optionally includes a midsole fitted between the upper 222 and the sole 220. In the illustrated embodiment, the footwear 200 is a running shoe, but it should be understood that wide range of footwear may be manufactured according to one or more embodiments of the present disclosure. For example, an embodiment according to the present disclosure may involve mid- or full-height boots (e.g., 8-10 inches), hiking shoes, pac boots, ski boots or essentially any other footwear that includes a sole and an upper.

The additive manufacturing system 100 according to one embodiment may enable deposition of one or more elements or features on the substrate 210, 300. After the one or more elements or features have been deposited, the footwear 200 may be substantially complete and ready to wear. Alternatively, one or more additional manufacturing steps may be performed to complete the article of footwear 200, including adhering an outsole to the footwear 200. In the illustrated embodiment, the outsole is manufactured for the footwear 200 by the additive manufacturing system 100. Indeed, the outsole is shown partially complete as element 218 with the remaining incomplete portion shown in phantom.

The illustrated embodiment of FIG. 6 depicts one or more features 212, 214, 218 deposited on or in proximity to the footwear last 110 by the additive manufacturing system 100. The one or more features 212, 214, 218 may be deposited in accordance with instructions provided to the articulating manipulator 112 and the nozzle unit 114. The instructions may be based on a digital model of footwear to be purchased by a consumer.

The instructions in one configuration may be based on one or more customization parameters provided by the consumer, such as color, size, outsole use case (e.g., hiking with larger lugs), with a tendency toward pronation or supination. The one or more customization parameters may be provided at the point of sale or point of transaction so that the footwear 200 may be manufactured to order. Made to order type configurations may allow a consumer to purchase footwear 200 from a prior year collection, or footwear 200 that has been conceptualized recently, bypassing the conventional manufacturing pipeline of the footwear industry and bringing a concept to market much sooner.

The additive manufacturing system 100 may deposit the one or more deposited features 212, 214, 218 using several types of materials 115 as discussed herein, providing a feature or features with varying properties. For instance, materials 115 that are elastomeric or polymeric materials having a relative softness (e.g., a Shore A below 65) may be deposited in areas that withstand a large degree of flex while in use, whereas another area may be provided with material that is much harder, such as a lace hole. In one embodiment, the material 115 deposited material on the substrate 300 impregnates or fuses with the material of the substrate 300, thereby joining with the material of the substrate 300.

It should be understood that, in depositing material in layers to form the deposited features 212, 214, 218, the type of material may vary from one region to another of a particular feature. For instance, deposited feature 214 in the illustrated embodiments of FIGS. 1 and 7 is depicted with a plurality of apertures 230, one or more of which may function as lace holes to support laces. When laces are tightened, there is a significant amount of force applied to an aperture functioning as a lace support. This can result in failure if the material forming the aperture is insufficiently configured to withstand such force, and so the material deposited for forming the lace apertures may be selected for its stiffness or durability. In one example, if the material type of deposited feature 214 is substantially uniform, the material type may be selected to balance strength near the lace aperture against pliability near the sole to prevent substantial restriction of movement. In another example, the material type deposited to form the lace aperture 230 may be much stronger than the material type deposited proximal to the sole 220.

In one embodiment, one or more deposited features on the substrate 210, 300 (or on the footwear last 110) may vary in texture at different regions of the footwear 200. The different regions may be adjacent and seamless as one feature or part of two or more separate features. In the illustrated embodiment of FIG. 7, the deposited feature 214 on the substrate 300 includes at least four different textures or structural configurations designated as 224, 226, 228, 230. The deposited feature 214 may also be provided with apertures 234 or any other type of structural configuration formed of deposited material or a void of deposited material. Indeed, a feature deposited on the substrate or the footwear last 110 may include internal voids or voids between layers.

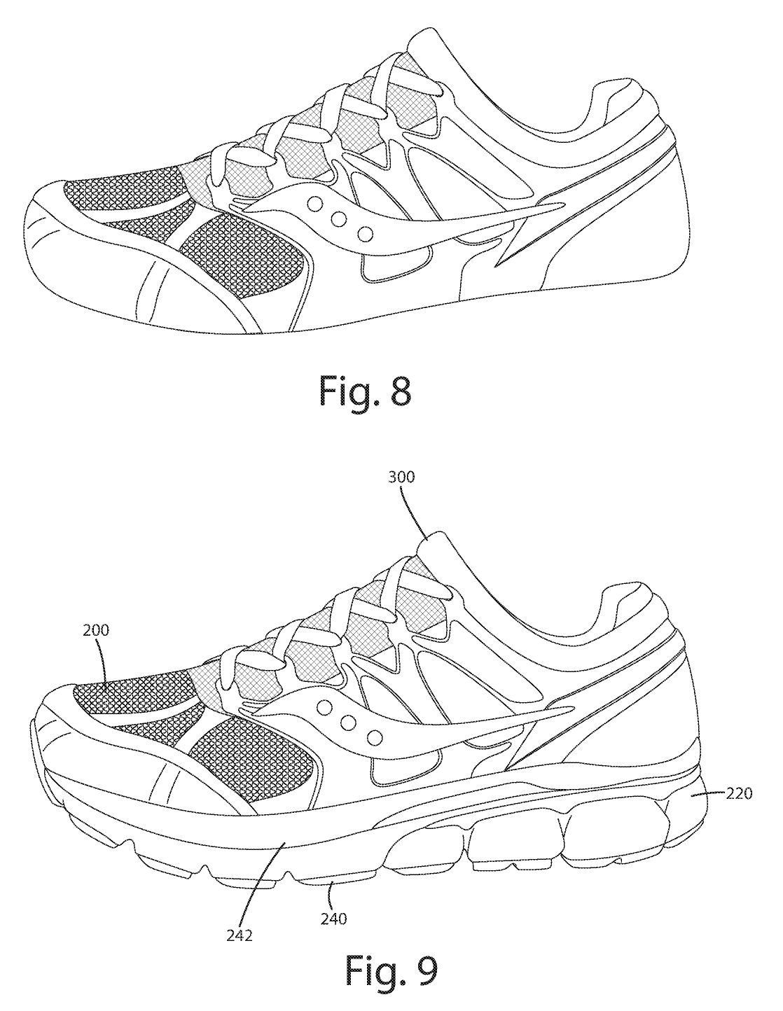

FIG. 7 depicts the deposited feature 214 according to one embodiment with varying structural features deposited on the substrate 300. It should be noted that, for purposes of disclosure, deposited material in FIG. 7 is shown in yellow while portions of the substrate 300 that remain visible are greyed out as compared to the illustrated embodiment of FIG. 8, which shows both the deposited material and visible substrate without being greyed out.

In the illustrated embodiment of FIG. 7, the deposited feature 214 may include a heel strap 224 that traverses from the medial side, instep region to a portion of the heel near the ankle opening 350, to the lateral side and across the instep region. This heel strap 224 configuration may enhance support provided by the substrate 300 when in use with a foot. As can be seen, the thickness and texture of the heel strap 224 provides more material 115 for strength over adjacent aspects 226 of the deposited feature 214. The heel strap 224 in this configuration is a single unitary piece deposited on the substrate 300.

Material 115 adjacent to the heel strap 224 and also forming part of the deposited element 214 may also be deposited on the heel area of the substrate 300, the medial and lateral sides and the instep region.

Material 115 can be deposited anywhere on the substrate 300 by the additive manufacturing system 100 to form any type of feature that can be built out in layers along one or more deposition axes. For instance, material 115 may be deposited at any location of the substrate 300, or 360° about any axis and any position along such axis as shown in the reference frame 130.

As an example, material 115 may be deposited on opposite surfaces of the substrate 300, along a deposition axis that is normal to each of the opposite surfaces. The normals may be substantially parallel to each other. For instance, the normals depicted in FIG. 2 and designated 132, 134 are provided on opposing surfaces and substantially parallel to each other.

In another example, as discussed herein, the material 115 may be successively deposited on the substrate to form the deposited features 212, 214, 218 along a deposition axis that may vary between and/or within the layers of the deposited features. For instance, the footwear last 110 (not shown in FIG. 7) may rotate the substrate 300 so that the lateral side is perpendicular to the deposition axis of the nozzle 116. Material 115 may be deposited to form at least part of the deposited feature 214, and then the substrate 300 may be rotated so that the sole of the substrate 300 is perpendicular to the deposition axis of the nozzle 116. Material 115 may be deposited on the substrate 300 in this position. Further movements and deposition of material 115 may be effected until the digital model of the footwear 200 with respect to the deposited features is complete.

In another example, the deposited feature 212 near the toe box includes material deposited on five sides of the substrate 300. The deposited feature 212 may be integrally joined with the deposited feature 214 so that the material 115 is deposited on six sides of the substrate 300, i.e., the heel strap 224 represents material deposited on the sixth side in this example. It should be understood that material may be deposited in layers on the substrate 300 at any position thereon.

The article of footwear 200 may include essentially any sole construction, as described herein at Section V. For instance, the footwear 200 may be provided with a separately manufactured sole or a sole manufactured in a manner similar to the deposited features 212, 214.

Turning to the illustrated embodiment of FIG. 9, one or more surface finishes or surface decorations or color blocking may be applied to the article of footwear 200. For instance, a surface decoration with one or more colors and optional lettering may be applied to the article of footwear 200. The surface decoration may take the form of a transfer sheet to which a vacuum is applied with respect to the article of footwear 200. An example of such technology is sold under the tradename TriChord.

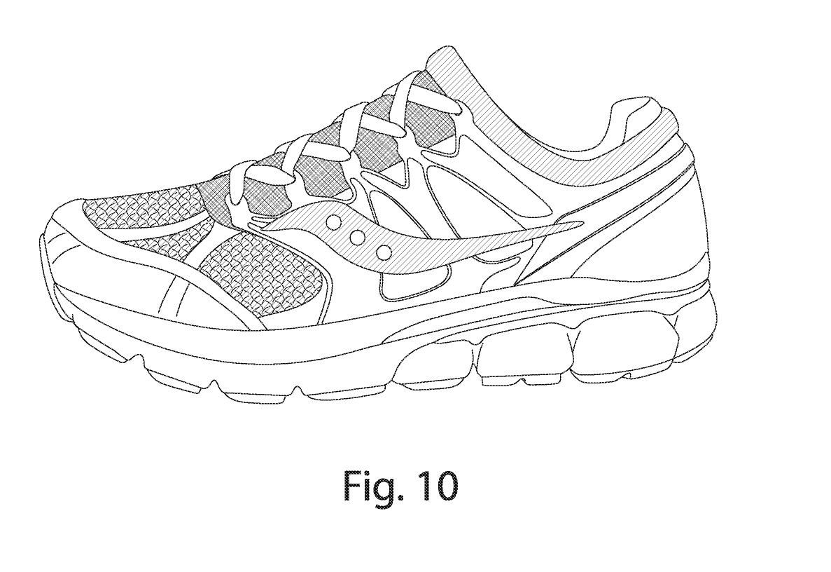

With application of the vacuum, the transfer sheet may conform to the shape of the footwear 200. Heat may be applied to the transfer sheet and/or the footwear 200 to transfer a decoration imparted on the sheet to the footwear 200. The result of such a transfer is depicted in the illustrated embodiment of FIG. 10 with a variety of coloring and designs for different areas and text. The decoration provided on the transfer sheet may be mapped as a UV translation of a three-dimensional decoration on the digital model of the footwear 200 to a two-dimensional sheet that, when distorted to conform to the footwear, physically aligns the decorations to the footwear 200 according to the three-dimensional decoration.

In one embodiment, registration between the footwear 200 and the transfer sheet may be achieved via positioning of the footwear 200 on a perforated base with registration pins configured to align with registration openings in the outsole of the footwear 200. The openings may be manufactured with the additive manufacturing system 100 in accordance with a 3-D digital model. In an alternative embodiment, the outsole of the footwear 200 may be provided with one or more registrations protrusions or pins that align with perforations of the perforated base. The protrusions or pins may project from the surface of the outsole according to a 3-D model, and may be manufactured as part of the outsole with the additive manufacturing system 100. The protrusions or pins according to one configuration may be broken free from the outsole or removed from the outsole after color blocking or decorations have been transferred from the transfer sheet.

The transfer sheet may register with the base by alignment of one or more apertures in the sheet that align with one or more registration pins on the base. A vacuum may be applied to the perforated so that the transfer sheet conforms substantially to the footwear 200, and heat may be applied to the footwear 200 and the transfer sheet to transfer the decoration or color blocking to the footwear 200.

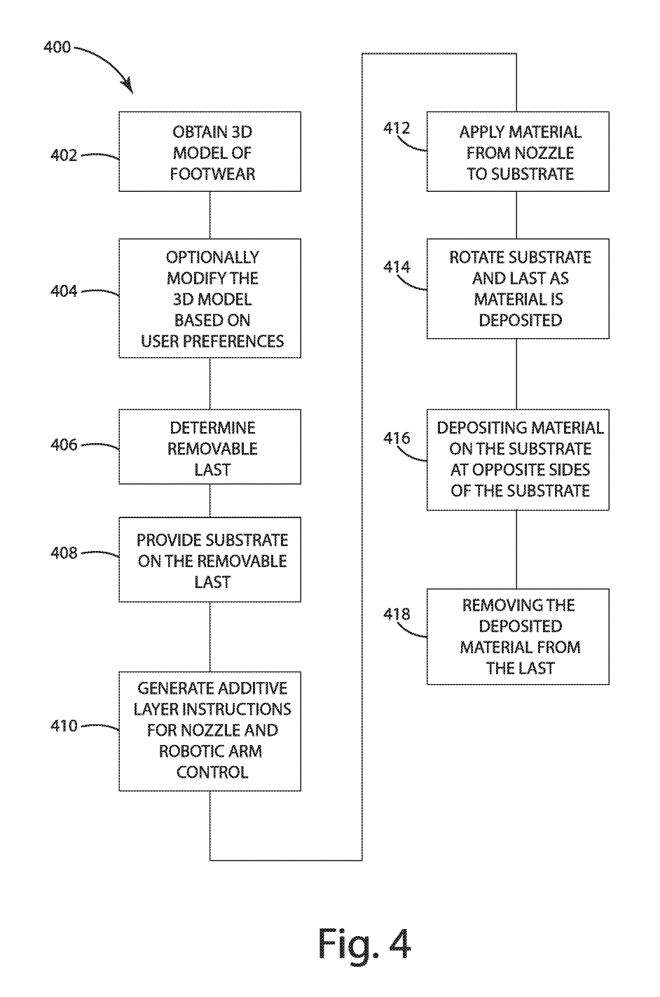

A method of manufacture according to one embodiment is depicted in the illustrated embodiment of FIG. 4, and generally designated 400. The method 400 may include obtaining a 3-dimensional model of footwear from a database or a description of the model. Step 402. The 3-dimensional model may be a variation of a default model that has been modified according to one or more consumer parameters. Step 404.

Based on the 3-dimensional model of footwear, a footwear last 110 may be selected that corresponds to a stick length associated with the model. As discussed herein, the footwear last 110 may be removable or separable from the article of footwear that will be manufactured in conjunction with the footwear last 110. Step 406. A substrate 210, 300 may be selected or manufactured based on the model of footwear, and slipped over the footwear last 110. Step 408.

The additive manufacturing system 100 may manipulate the footwear last 110 in space to deposit material 115 in layers with the nozzle unit 114. The spatial manipulations and feed of material 115 may be controlled by the additive manufacturing system 100 in accordance with instructions based on the 3-dimensional model of footwear. Steps 410, 412. For instance, the footwear last 110 including the substrate 210, 300 may be rotated relative to the nozzle unit 114 (alternatively the nozzle unit 114 may rotate relative to the footwear last), as material 115 is deposited by the nozzle unit 114 on the substrate 210, 300. Step 414. As discussed herein, the deposition axis for one area of the substrate 210, 300 may be different from the deposition axis for another area. In this way, different areas of the substrate 210, 300 may be built up in different directions. As an example, material may be deposited on opposing surfaces or sides of the substrate 210, 300 with the deposition axis for each surface being normal to the surface. Step 416. The material deposited on the substrate 210, 300 may form one or more aspects of the article of footwear, including but not limited to lace supports, a toe cap, a heel strap, instep support, a logo, a midsole, and an outsole. After the material 115 has been deposited on the substrate 210, 300, the article of footwear may be removed from the footwear last 110. Step 418.

V. Sole Construction

The article of footwear 200 may include essentially any sole construction. In one embodiment, the sole 220 may be manufactured separately from the substrate 210 and the material 115 deposited by the additive manufacturing system 100. The sole 220 may be a conventional sole, such as an injection molded outsole and midsole that is adhered to the footwear 200 after the material 115 has been deposited.

In the illustrated embodiment of FIG. 9, the sole 220 is formed of material 115 deposited by the additive manufacturing system 100. The sole 220, as discussed herein, may be customized to one or more consumer preferences or parameters, such as additional arch support or variances in midsole thickness in one or more areas to more evenly distribute a wearer's weight (e.g., by increasing the thickness in the heel region, the wearer's center of gravity may be slightly adjusted to more evenly distribute the wearer's weight, if the wearer tends to place more pressure on their heel). In one embodiment, the midsole 242 may include one or more voids provided by the additive manufacturing system 100 to reduce the amount of the material 115 in some regions as compared to other regions of the midsole 242. For instance, in an area near the heel, the additive manufacturing system 100 may deposit material in a type of network of strands and voids that function as a cushion for the heel, whereas the instep region may be absent of such voids or voids that take up less space so that there is less cushion near the instep but more stability.

The sole 220 generally includes a midsole 242 and an outsole 240. Generally speaking, the midsole 242 provides cushioning for the wearer's foot and the outsole 240 provides durability and traction for the article of footwear 200. Although the midsole 242 may vary from application to application, the midsole 242 of the illustrated embodiment is manufactured from a type of material 115 that is a relatively resilient material selected to provide the article of footwear 200 with a desired level of cushioning. For example, the midsole 242 may be formed from foam material that is capable of being deposited in layers on or in proximity to the footwear last 110. The midsole 242 generally includes an upper part and a lower part, where the upper part may be deposited directly on the substrate 210, 300 to join therewith or deposited features 212, 214 to join therewith, or a combination thereof.

The lower part of the midsole 242 may form a junction between the midsole 242 and the outsole 240, which may be provided as a type of material 115 that is more durable and less resilient than the type of the material 115 used for the midsole 242. The junction may be generally seamless in that the materials of the midsole 242 and outsole 240 are fused together. Alternatively, the outsole 240 may be manufactured separately and adhered or molded onto the midsole 242.

In the illustrated embodiment of FIGS. 1 and 9, the outsole 240 may be formed a type of the material 115 that is selected to provide the desired balance between comfort, wear, traction and cost. For example, the type of material 115 for outsole 240 may be similar to a conventional rubber compound or from other suitable wear-resistant materials. The outsole 240 may include treads and/or lugs or be otherwise configured to enhance traction.

As discussed herein, the outsole 240 may be customized according to one or more consumer parameters, optionally obtained at the point of sale, so that the footwear 200 is customized to the particular consumer. To provide an example, the consumer may indicate a particular type of use for the footwear 200 such as hiking or walking. In the case of hiking, the lug depth provided on the outsole 240 may be increased for greater traction in rocky or uneven surface conditions. On the other hand, in the case of walking, the lug depth may be reduced to provide greater stability on generally flat surface conditions. The additive manufacturing system 100 may receive a model or manufacturing instructions corresponding to a model that represents the type of lug depth for the desired footwear.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A method of manufacturing an article of footwear comprising:
providing a footwear last shaped to approximate a human foot for the type of footwear being manufactured, wherein the footwear last approximates a stick length, a ball girth, and a instep girth of the human foot, the footwear last having a bridge zone of an upper surface, a sole zone of a lower surface, a medial surface, and a lateral surface;
depositing material from a nozzle unit on or in proximity to a first zone of the footwear last;
rotating one of the footwear last relative and the nozzle unit relative to the other of the footwear last and the nozzle unit;
depositing material from the nozzle unit on or in proximity to a second zone of the footwear last; and
separating the material deposited from the nozzle unit and the footwear last to yield the footwear with a void that accepts the human foot.

2. The method of claim 1 wherein the first zone is opposite the second zone of the footwear last.

3. The method of claim 1 wherein said depositing material on or in proximity to the first zone includes layering material in a first deposition axis, and wherein said depositing material on or in proximity to the second zone includes layering the material in a second deposition axis, wherein the first deposition axis is different from the second deposition axis.

4. The method of claim 1 comprising removably disposing a substrate on the footwear last; and wherein said depositing material includes depositing material from the nozzle unit on the substrate.

5. The method of claim 4 wherein the substrate includes a knit material that forms a type of sock that is slipped over the footwear last and on which the material is deposited.

6. The method of claim 4 comprising after the material is deposited on the substrate, removing the substrate with the material from the footwear last.

7. The method of claim 1 wherein said depositing material on or in proximity to the second zone includes generating an outsole that provides traction to a wearer of the footwear in use, wherein the second zone is the sole zone.

8. The method of claim 7 wherein the material deposited on or in proximity to the sole zone is a foam material, and wherein the foam material is different from the material deposited on or in proximity to the first zone of the footwear last.

9. The method of claim 1 wherein the first zone is the bridge zone and the second zone is the sole zone.

10. The method of claim 9 wherein the footwear last is rotated greater than 180° relative to the nozzle unit, and comprising depositing material on or in proximity to the lateral surface and the medial surface.

11. An article of footwear comprising:
an upper formed at least in part of material deposited by a nozzle unit on or in proximity to a footwear last that is held in space relative to a nozzle unit, wherein material is deposited with the nozzle unit being aligned with a normal to a first surface at a first position of the footwear last, wherein material is deposited with the nozzle unit being aligned with a normal to a second surface at a second position of the footwear last; and
wherein the first surface is opposite the second surface, and wherein the normal to the first surface is parallel with the normal to the second surface.

12. The article of footwear of claim 11 wherein the nozzle unit is configured to deposit more than one type of material such that a first type of material is deposited on the first surface and a second type of material is deposited on the second surface.

13. The article of footwear of claim 11 comprising a sole structure formed at least in part of material deposited by the nozzle unit.

14. The article of footwear of claim 13 wherein a type of material deposited from the nozzle unit to form the sole structure is foam.

15. The article of footwear of claim 11 wherein the footwear last includes an upper surface with a bridge zone, a lower surface with a sole zone, a medial surface, and a lateral surface, and wherein the first surface is the upper surface and the second surface is the lower surface.

16. The article of footwear of claim 15 wherein material is deposited by the nozzle unit on each of the upper surface, the lower surface, the medial surface, and the lateral surface.

17. The article of footwear of claim 11 wherein a substrate is disposed on the footwear last, wherein material is deposited by the nozzle unit on the substrate, wherein the substrate and the material are separated from the footwear last to yield the article of footwear with a void that accepts a human foot.

18. The article of footwear of claim 17 wherein the substrate is a knit base shaped to approximate the human foot and including a void that accepts the human foot.

19. A method of manufacture for an article of footwear, the method comprising:
mechanically manipulating a yarn with a knitting machine to form a knitted portion of an upper having a void that accepts a human foot;
disposing the knitted portion over a footwear last shaped to approximate the human foot for a type of footwear being manufactured, wherein the footwear last approximates a stick length, a ball girth, and an instep girth of the human foot, the footwear last having a bridge zone of an upper surface, a sole zone of a lower surface, a medial surface, and a lateral surface; and
depositing material from a nozzle unit on the knitted portion to provide at least one of an upper feature and an outsole.

20. The method of claim 19 comprising rotating the footwear last relative to the nozzle unit between first and second positions, and depositing material on the knitted portion at the first position and the second position.

21. The method of claim 19 wherein the upper feature is disposed on a lateral surface of the knitted portion, and the knitted portion is removed from the footwear last.

22. The method of claim 19 wherein said mechanically manipulating the yarn includes manipulating the yarn according to at least two stitch configurations.

23. A manufacturing system for producing an article of footwear, the manufacturing system comprising:
a footwear last disposable within an upper element, the upper element defining an ankle opening and a void in an interior of the footwear to receive a human foot, the upper element configured to extend around a heel area of the human foot, over a toe area of the human foot, and along medial and lateral sides of the human foot, the footwear last including first and second surface normals that are not parallel;
a nozzle unit configured to deposit material in layers on an upper element, the nozzle unit configured to deposit material along a deposition axis; and
an articulating manipulator operably coupled to one of the footwear last and the nozzle unit, the articulating manipulator configured to vary a relative position between the footwear last and the nozzle unit to align the deposition axis and the first surface normal, the articulating manipulator configured to vary the relative position between the footwear last and the nozzle unit to align the deposition axis and the second surface normal.

24. The manufacturing system of claim 23 wherein the deposition axis is vertical.

25. The manufacturing system of claim 23 wherein a rotational axis of the footwear last is varied to vary the relative position between the footwear last and the nozzle unit.

26. The manufacturing system of claim 23 comprising a knitting machine configured to mechanically manipulate yarn to form a textile element incorporated into the upper element.

27. The manufacturing system of claim 26 wherein the textile element includes at least two types of stitch configurations.

28. An article of footwear comprising:
an upper element defining an ankle opening and a void in an interior of the upper element to receive a human foot, the upper element configured to extend around a heel area of the human foot, over a toe area of the human foot, and along medial and lateral sides of the human foot;
a first plurality of layers deposited by a nozzle unit on the upper element along a first deposition axis; and
a second plurality of layers deposited by the nozzle unit on the upper element along a second deposition axis, the first deposition axis being different from the second deposition axis such that the first plurality of layers is built along a direction different from a build direction of the second plurality of layers.

29. The article of claim 28 wherein an nozzle deposition axis between the nozzle unit and the upper element is variable, and wherein each of the first plurality of layers is deposited while the first deposition axis is substantially vertical, and wherein each of the second plurality of layers is deposited while the second deposition axis is substantially vertical.

30. The article of claim 28 wherein the upper element is a non-3D printed component.

31. The article of claim 30 wherein the non-3D printed component is a knit upper formed of mechanically manipulated yarn.

32. The article of claim 28 wherein the first and second plurality of layers integrally form a footwear element that follows a contour of the upper element.

33. The article of claim 32 wherein the footwear element provides a lace support for laces that facilitate tightening the footwear about the human foot.

34. The article of claim 28 wherein the first plurality of layers form at least one of an outsole and a midsole of the footwear.
